(19) United States
(12) Patent Application Publication
(10) Pub. No.: US 2023/0142181 A1
(43) Pub. Date: May 11, 2023

(54) SNOW MELTING APPARATUS

(71) Applicant: DENSO CORPORATION, Kariya-city (JP)

(72) Inventor: NORIAKI IKUMA, Kariya-city (JP)

(21) Appl. No.: 17/980,830

(22) Filed: Nov. 4, 2022

(30) Foreign Application Priority Data
Nov. 8, 2021 (JP) 2021-181868

(51) Int. Cl. B60S 1/02; H05B 1/02

(52) U.S. Cl. CPC B60S 1/026; H05B 1/0236; H05B 2203/005

(57) ABSTRACT

A wiper system includes a wiper blade to wipe a windshield, an angle sensor, and a motor. The motor drives the wiper blade to reverse a wipe operation of the wiper blade at a reversal position based on the angle sensor, such that rotation of the motor when the wiper blade moves to a released position is reversed to rotation of the motor when the wiper blade moves to a standby position. A first heating element is installed near a front pillar and generates heat when energized. A determiner determines whether snow accumulates on a surface of the windshield based on an operation of the wiper system. A controller controls energization of the first heating element and energizes the first heating element on determination of the determiner that snow accumulates on the surface of the windshield.

### CROSS REFERENCE TO RELATED APPLICATION

The present application is based on Japanese Patent Application No. 2021-181868 filed on Nov. 8, 2021. The entire disclosures of all of the above applications are incorporated herein by reference.

### TECHNICAL FIELD

The present disclosure relates to a snow melting apparatus.

### BACKGROUND

Conventionally, a heating apparatus has been used to heat a window glass of a vehicle.

### SUMMARY

According to an aspect of the present disclosure, a wiper system includes a wiper blade to wipe a windshield, an angle sensor, and a motor. The motor is configured to drive the wiper blade to reverse a wipe operation of the wiper blade at a reversal position based on the angle sensor, such that rotation of the motor when the wiper blade moves to a released position is reversed to rotation of the motor when the wiper blade moves to a standby position.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a configuration of a snow melting system;

FIG. 2A is an explanatory diagram illustrating a windshield where snow accumulates;

FIG. 2B is an explanatory diagram illustrating a wiper blade moved to a standby position;

FIG. 2C is an explanatory diagram illustrating a wiper blade moved to a released position;

FIG. 2D is an explanatory diagram illustrating a first heating element provided for the windshield;

FIG. 3 is a block diagram illustrating a configuration of a wiper system;

FIG. 4 is an explanatory diagram illustrating a snow chunk detection range according to a first embodiment;

FIG. 5 is a flowchart illustrating a motor control process;

FIG. 6 is a flowchart illustrating a retraction process;

FIG. 7 is a flowchart illustrating a first snow chunk detection process according to the first embodiment;

FIG. 8 is a flowchart illustrating a second snow chunk detection process according to the first embodiment;

FIG. 9 is a flowchart illustrating the first snow chunk detection process according to a modification of the first embodiment;

FIG. 10 is a flowchart illustrating the second snow chunk detection process according to a modification of the first embodiment;

FIG. 11 is a flowchart illustrating the first snow chunk detection process according to a second embodiment;

FIG. 12 is an explanatory diagram illustrating a snow chunk detection range according to the second embodiment;

FIG. 13 is a flowchart illustrating the first snow chunk detection process according to a modification of the second embodiment;

FIG. 14A illustrates a configuration where a device included in the snow melting system supplies power to the first heating element and the second heating element; and

FIG. 14B illustrates a configuration where an external battery supplies power to the first heating element and the second heating element.

### DETAILED DESCRIPTION

Hereinafter, examples of the present disclosure will be described.

According to an example of the present disclosure, a window glass heating apparatus includes an inner heater and an outer heater. The inner heater is provided to the inner glass of a windshield and heats the entire surface of the windshield. The outer heater is provided to the outer glass of the windshield and heats part of the windshield near a wiper standby position and the front pillar. When a defogger switch is turned on, the window glass heating apparatus energizes the inner heater. When a de-icer switch is turned on, the window glass heating apparatus energizes the outer heater. According to an example of the present disclosure, a window glass heating apparatus energizes the inner and outer heaters when a wiper switch is turned on and when the outside air temperature is below 2° C. This configuration aims to melt the snow on the windshield to ensure good visibility.

An assumable configuration is to determine whether to energize the inner or outer heater based on conditions of the defogger switch and the outside temperature. The inventor has conducted a detailed examination and found the following issue in this assumable configuration. Specifically, the inner or outer heater may be energized even when the windshield is not covered with snow. Therefore, an inconvenience may arise due to unnecessarily energizing of the inner or outer heater.

According to an example of the present disclosure, a snow melting apparatus comprises a wiper system. The wiper system includes a wiper blade to wipe a windshield, an angle sensor, and a motor. The motor is configured to drive the wiper blade to reverse a wipe operation of the wiper blade at a reversal position based on the angle sensor, such that rotation of the motor when the wiper blade moves to a released position is reversed to rotation of the motor when the wiper blade moves to a standby position. The snow melting apparatus further comprises a first heating element installed near a front pillar and configured to generate heat when energized. The snow melting apparatus further comprises a determiner configured to determine whether snow accumulates on a surface of the windshield based on an operation of the wiper system. The snow melting apparatus further comprises a controller configured to control energization of the first heating element. The controller is configured to energize the first heating element on determination of the determiner that snow accumulates on the surface of the windshield.

This configuration may enable to efficiently melt snow on a windshield.

The description below explains embodiments of the present disclosure by reference to the accompanying drawings.

### 1. First Embodiment

1-1. Configuration

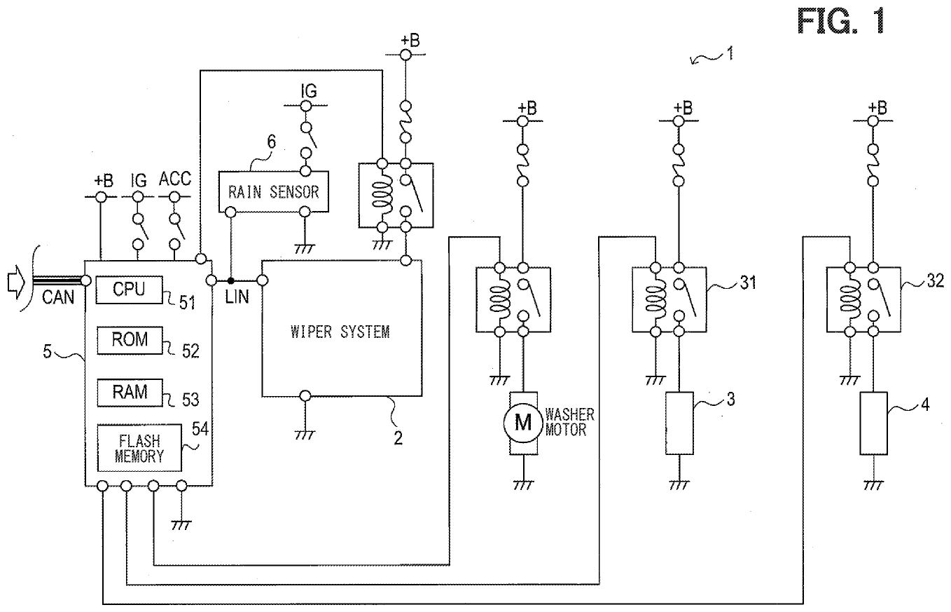

A snow melting system 1 illustrated in FIG. 1 is installed in vehicles. The snow melting system 1 includes a wiper system 2, a first heating element 3, a second heating element 4, a body ECU 5, and a rain sensor 6. The wiper system 2 and the body ECU 5 communicate with other ECUs and onboard devices via an onboard network configured as CAN or LIN. CAN stands for Controller Area Network. LIN stands for Local Interconnect Network. CAN is a registered trademark.

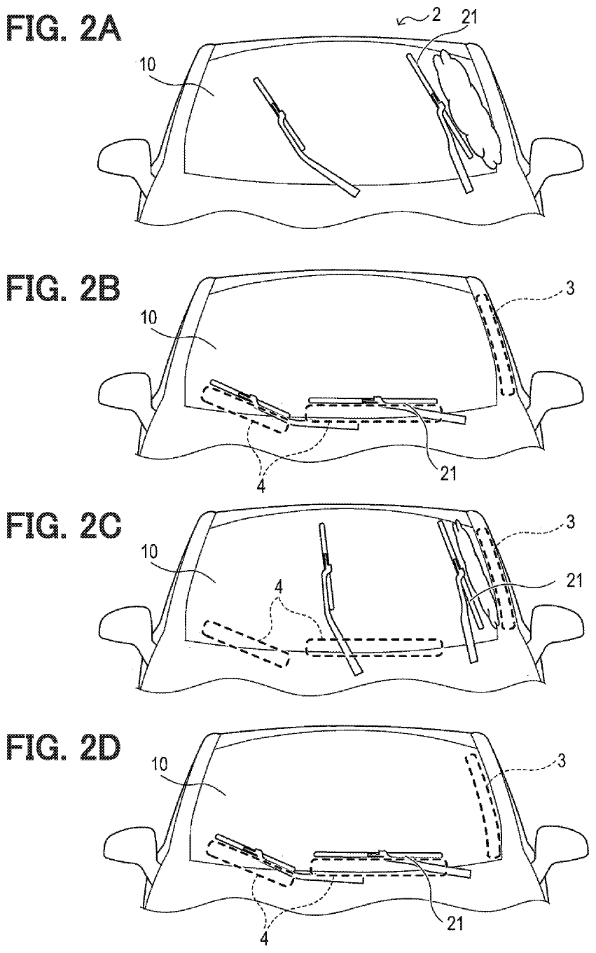

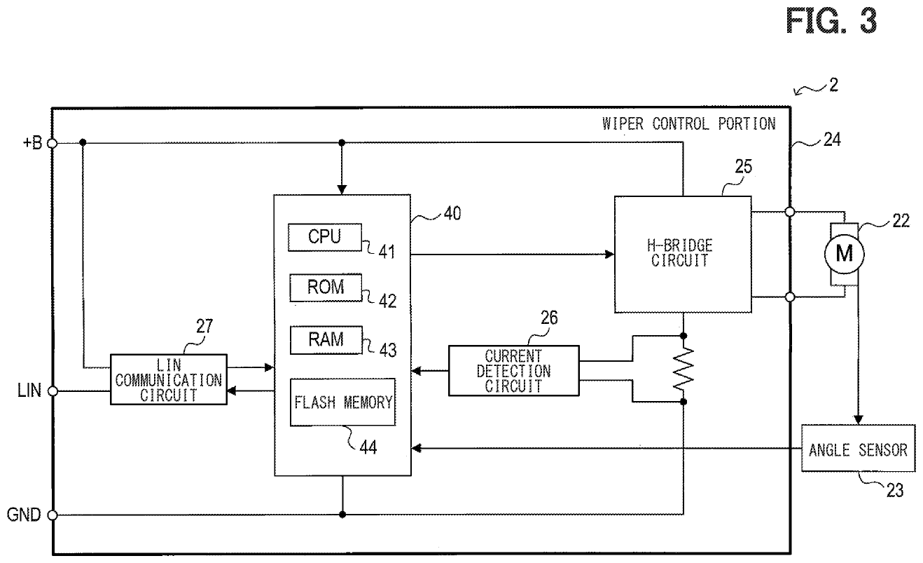

The wiper system 2 includes a wiper blade 21 illustrated in FIGS. 2A through 2D, and a wiper motor 22, an angle sensor 23, and a wiper control portion (wiper controller) 24 illustrated in FIG. 3.

The wiper blade 21 wipes off raindrops adhering to the windshield 10.

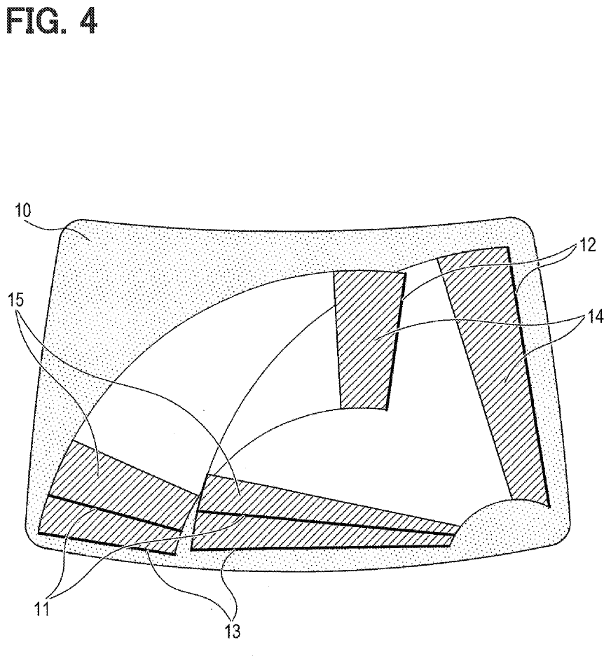

The wiper motor 22 drives the wiper blade 21. The wiper motor 22 can switch between normal rotation (forward) and reverse rotation (backward). FIG. 4 illustrates a standby position 11 and a released position 12. The direction in which the wiper blade 21 moves from the standby position 11 to the released position 12 is defined as the normal rotation of the wiper motor 22. The reverse of the same is defined as the reverse rotation. The released position 12 corresponds to a reversal position near the front pillar. The standby position 11 corresponds to a reversal position near the retracted position 13 of the wiper blade 21. The wiper blade 21 is retracted to the retracted position 13 when the wiper system 2 does not perform a wipe operation.

Returning to FIG. 3, the angle sensor 23 detects a rotational position of an output shaft of the wiper motor 22 that rotates a wiper rod (not shown). The angle sensor 23 outputs a rotation signal corresponding to the rotation angle of the output shaft against a reference position of the output shaft.

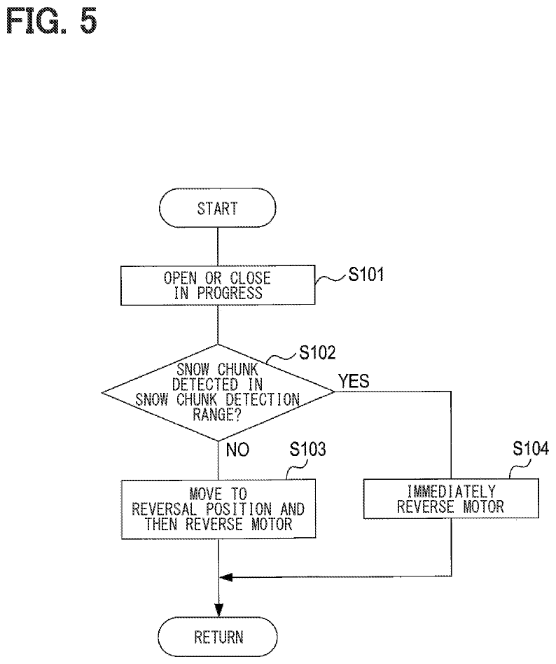

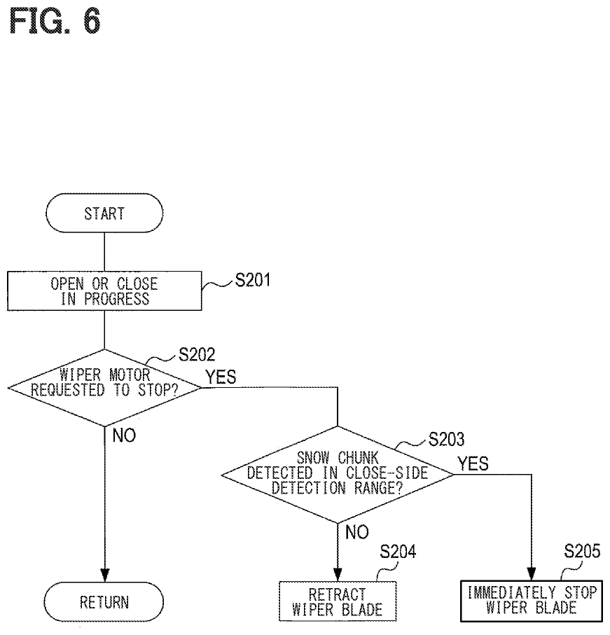

The wiper control portion 24 is mainly composed of a well-known microcomputer 40 including a CPU 41, ROM 42, RAM 43, and flash memory 44, for example. The CPU 41 executes a program stored in the ROM 42 as a non-transitory tangible storage medium. Execution of the program implements the method corresponding to the program. Based on the program, the wiper control portion 24 performs a motor control process illustrated in FIG. 5 and a retraction process illustrated in FIG. 6, to be described later. The wiper control portion 24 may include one or more microcomputers.

A technique to embody functions of the elements included in the wiper control portion 24 is not limited to the software. One or more hardware components may be used to embody all or part of the functions. When an electronic circuit as hardware implements the above-described functions, for example, the electronic circuit may be provided as a digital circuit, an analog circuit, or a combination of these.

When a rotation signal of the angle sensor 23 indicates the released position 12, the wiper control portion 24 controls the wiper motor 22 to rotate reversely. When a rotation signal of the angle sensor 23 indicates the standby position 11, the wiper control portion 24 controls the wiper motor 22 to rotate normally. By repeating this operation, the wiper blade 21 wipes the windshield 10 while reciprocating in a wiping range between the standby position 11 and the released position 12. The wiper system 2 reverses the rotation of the connected wiper motor 22 when the wiper blade 21 moves to the released position 12 and then to the standby position 11. The wipe operation of the wiper blade 21 reverses at the reversal position.

The voltage applied to the wiper motor 22 is generated based on PWM. The wiper control portion 24 includes an H-bridge circuit 25 using FETs as switching elements. The voltage at a predetermined duty ratio is output under the control of the wiper control portion 24.

The wiper control portion 24 includes a current detection circuit 26. The current detection circuit 26 detects current values output from the wiper motor 22.

The wiper control portion 24 includes a LIN communication circuit 27. The LIN communication circuit 27 transmits and receives frames compliant with the LIN communication protocol.

The wiper control portion 24 outputs a snow chunk detection signal. The snow chunk detection signal indicates that snow accumulates on the windshield 10. The method of determining whether snow accumulates on the windshield 10 will be described in detail later.

The first heating element 3 illustrated in FIGS. 1 and 2B is provided inside the front pillar and generates heat when energized. For example, a relay 31 turns on and energizes the first heating element 3 when the body ECU 5 outputs a signal to turn on the first heating element 3. The first heating element 3 is powered by a battery.

The second heating element 4 is provided near the standby position of the wiper blade 21 and generates heat when energized. For example, a relay 32 turns on and energizes the second heating element 4 when the body ECU 5 outputs a signal to turn on the second heating element 4. The second heating element 4 is powered by a battery.

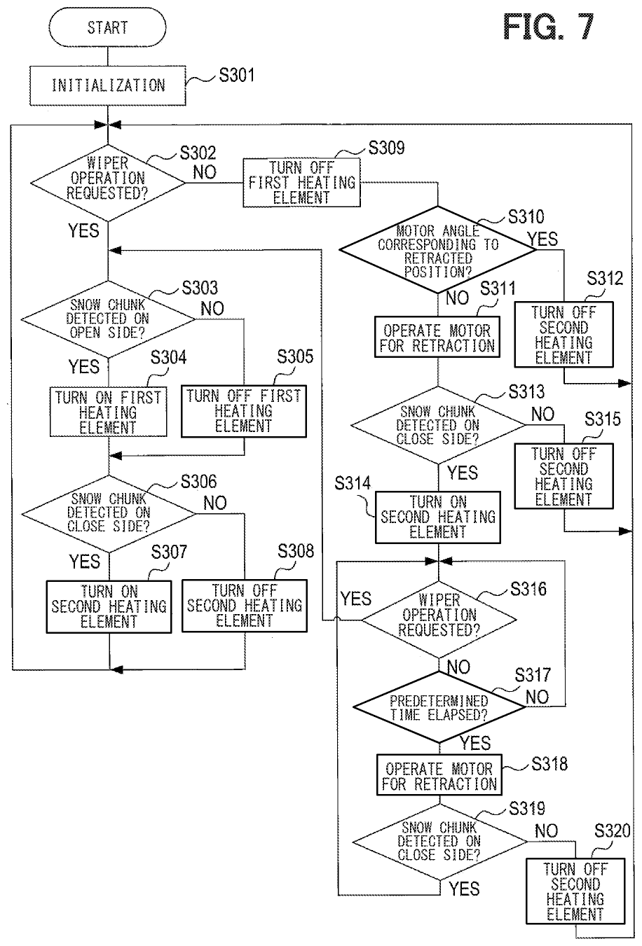

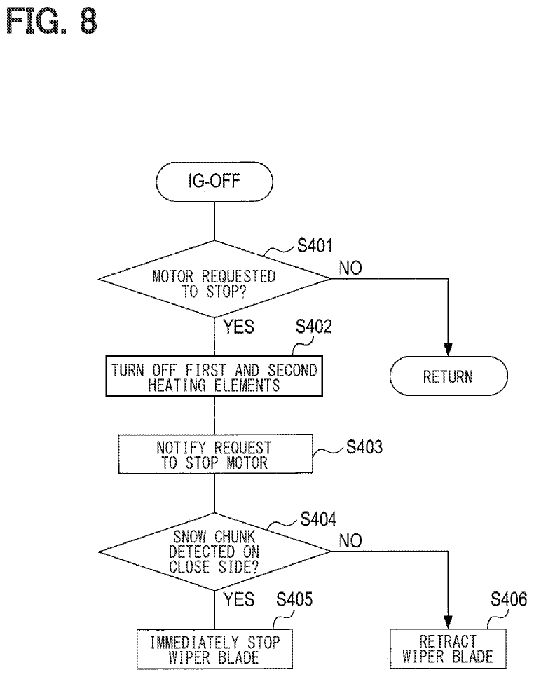

The body ECU 5 is mainly composed of a well-known microcomputer including a CPU 51, ROM 52, RAM 53, and flash memory 55, for example. The CPU 51 executes a program stored in the ROM 52 as a non-transitory tangible storage medium. Execution of the program implements the method corresponding to the program. Based on the program, the body ECU 5 performs a first snow chunk detection process illustrated in FIG. 7 and a second snow chunk detection process illustrated in FIG. 8, to be described later. The body ECU 5 may include one or more microcomputers.

A technique to embody functions of the elements included in the body ECU 5 is not limited to the software. One or more hardware components may be used to embody all or part of the functions. When an electronic circuit as hardware implements the above-described functions, for example, the electronic circuit may be provided as a digital circuit, an analog circuit, or a combination of these.

The body ECU 5 may determine that the amount of raindrop exceeds a predetermined raindrop threshold, based on a raindrop signal (to be described) output from the rain sensor 6. Then, the body ECU 5 outputs a signal to the wiper system 2 to start the wipe operation. The body ECU 5 also outputs a signal to the wiper system 2 to start the wipe operation when a driver turns on a wiper switch (not shown).

The rain sensor 6 detects the amount of raindrop adhering to the windshield 10. The rain sensor 6 is provided for the wiping range of the windshield 10. The amount of light received by a light receiving element is assumed to be 100% under the condition of the windshield 10 with no raindrops. The rain sensor 6 detects a change in the amount of received light as the amount of raindrop. Namely, the rain sensor 6 detects a decrease in the amount of received light as the amount of raindrop. The rain sensor 6 outputs a raindrop signal, indicating the amount of raindrop, to the body ECU 5.

1-2. Processes

1-2-1. Motor Control Process

By reference to a flowchart illustrated in FIG. 5, the description below explains a motor control process performed by the CPU 41 of the wiper control portion 24 when the wiper system 2 is performing the wipe operation.

In S101, the CPU 41 controls the wiper motor 22 so that the wiper blade 21 operates according to the normal rotation or the reverse rotation.

In S102, the CPU 41 determines whether snow accumulates in the snow chunk detection range on the surface of the windshield 10. The snow chunk detection range includes an open-side detection range 14 and a close-side detection range 15 illustrated in FIG. 4. The open-side detection range 14 corresponds to a predetermined area from the released position 12 toward the standby position 11. The close-side detection range 15 is a combination of a standby-side detection range and a retraction-side detection range. The standby-side detection range corresponds to a predetermined area from the standby position 11 toward the released position 12. The retraction-side detection range corresponds to an area from the retracted position 13 to the standby position 11.

Whether snow accumulates in the snow chunk detection range is determined based on the value of the angle sensor 23 and the output current value of the wiper motor 22. Specifically, it is determined that snow accumulates in the snow chunk detection range when all of the following four conditions are satisfied. The CPU 41 identifies the conditions that the angle sensor 23 indicates an angle corresponding to the open-side detection range 14; the rotation speed of the wiper motor 22 is slower than a predetermined speed threshold; the output current value of the wiper motor 22 is larger than a predetermined current threshold; a predetermined time has elapsed. In this case, it is determined that snow accumulates in the open-side detection range 14. It may be determined that a snow chunk is detected in the open-side detection range 14 in three successive cycles, for example. Then, the CPU 41 may confirm that the snow chunk is detected toward the released position 12. The determination that a snow chunk is detected is synonymous with the determination that snow accumulates. There may be conditions that the angle sensor 23 indicates an angle corresponding to the close-side detection range 15; the rotation speed of the wiper motor 22 is slower than a predetermined speed threshold; the output current value of the wiper motor 22 is larger than a predetermined current threshold; a predetermined time has elapsed. When these conditions are all satisfied, the CPU 41 determines that snow accumulates in the close-side detection range 15. It may be determined that snow accumulates in the open-side detection range 14 or the close-side detection range 15. Then, the CPU 41 determines that snow accumulates in the snow chunk detection range. The CPU 41 outputs a snow chunk detection signal representing the information about snow accumulation in the open-side detection range 14 as well as the information about snow accumulation in the close-side detection range 15. The CPU 41 operates the wiper blade 21 with a predetermined torque and continues the wipe operation while it is determined that no snow accumulates in the snow chunk detection range. At this time, the CPU 41 provides control so that the output current value of the wiper motor 22 conforms to a predetermined output value. The continued wipe operation can push the snow, adhering to the surface of the windshield 10, toward the front pillar and the standby position.

In S102, it may be determined that no snow accumulates in the snow chunk detection range. Then, the CPU 41 proceeds to S103.

In S103, the CPU 41 controls the wiper motor 22 so that the wiper blade 21 moves to the reversal position and then reverses. Then, the CPU 41 returns to S101.

In S102, it may be determined that snow accumulates in the snow chunk detection range. Then, the CPU 41 controls the wiper motor 22 so that the wiper blade 21 reverses immediately. Then, the CPU 41 returns to S101.

1-2-2. Retraction Process

By reference to a flowchart illustrated in FIG. 6, the description below explains a retraction process performed by the CPU 41 of the wiper control portion 24 when the wiper blade 21 is directed to be retracted.

In S201, the CPU 41 controls the wiper motor 22 so that the wiper blade 21 operates according to the normal rotation or the reverse rotation.

In S202, the CPU 41 determines whether the wiper motor 22 is requested to stop. Whether the wiper motor 22 is requested to stop is determined based on a signal output from the body ECU 5 when the wiper switch is turned off, or a signal output from the body ECU 5 when the amount of raindrop is determined to be smaller than a predetermined raindrop threshold.

In S201, it may be determined that the wiper motor 22 is not requested to stop. Then, the CPU 41 returns to S201.

It may be determined that the wiper motor 22 is requested to stop. Then, the CPU 41 proceeds to S203.

In S203, the CPU 41 determines whether snow accumulates in the close-side detection range 15.

In S203, it may be determined that no snow accumulates in the close-side detection range 15. Then, the CPU 41 proceeds to S204 and controls the wiper motor 22 so that the wiper blade 21 moves to the retracted position 13.

In S203, it may be determined that snow accumulates in the close-side detection range 15. Then, the CPU 41 proceeds to S205 and controls the wiper motor 22 so that the wiper blade 21 stops immediately.

1-2-3. First Snow Chunk Detection Process

By reference to a flowchart illustrated in FIG. 7, the description below explains a first snow chunk detection process performed by the CPU 51 of the body ECU 5. This process is repeatedly performed while the ignition switch is turned on.

In S301, the CPU 51 performs an initialization process. Specifically, the CPU 51 assigns initial values to parameters.

In S302, the CPU 51 determines whether there is a wiper operation request. The wiper operation request signifies a request to turn on the wiper switch. The request to turn on the wiper switch includes a request for wiping speed. The CPU 51 determines whether there is a wiper operation request based on the raindrop signal output from the rain sensor 6 or the information that the driver turns on the wiper switch.

In S302, it may be determined that there is a wiper operation request. Then, the CPU 51 proceeds to S303.

In S303, the CPU 51 determines whether snow accumulates in the open-side detection range 14. The CPU 51 determines whether snow accumulates in the open-side detection range 14, based on the snow chunk detection signal received from the wiper control portion 24. S303 is comparable to a process as a determination portion (determiner).

In S303, it may be determined that snow accumulates in the open-side detection range 14. Then, the CPU 51 proceeds to S304 and turns on the first heating element 3. S304 is comparable to a process as a control portion.

In S303, it may be determined that no snow accumulates in the open-side detection range 14. Then, the CPU 51 proceeds to S305 and turns off the first heating element 3.

In S306, the CPU 51 determines whether snow accumulates in the close-side detection range 15. The CPU 51 determines whether snow accumulates in the close-side detection range 15, based on the snow chunk detection signal received from the wiper control portion 24.

In S306, it may be determined that snow accumulates in the close-side detection range 15. Then, the CPU 51 proceeds to S307 and turns on the second heating element 4. Then, the CPU 51 returns to S302.

In S306, it may be determined that no snow accumulate in the close-side detection range 15. Then, the CPU 51 proceeds to S308 and turns off the second heating element 4. Then, the CPU 51 returns to S302.

In S302, it may be determined that there is no wiper operation request. Then, the CPU 51 proceeds to S309 and turns off the first heating element 3. Then, the CPU 51 proceeds to S310.

In S310, the CPU 51 determines whether a rotation signal of the angle sensor 23 for the wiper motor 22 indicates the retracted position 13. The rotation signal is input from the wiper control portion 24.

In S310, it may be determined that the rotation signal of the angle sensor 23 for the wiper motor 22 does not indicate retracted position 13. Then, the CPU 51 proceeds to S311 and outputs a signal to the wiper control portion 24 so that the wiper blade 21 is retracted to the retracted position 13.

In S310, it may be determined that the rotation signal of the angle sensor 23 for the wiper motor 22 indicates the retracted position 13. Then, the CPU 51 proceeds to S312 and turns off the second heating element 4. Then, the CPU 51 returns to S302.

In S313, the CPU 51 determines whether snow accumulates in the close-side detection range 15.

In S313, it may be determined that snow accumulates in the close-side detection range 15. Then, the CPU 51 proceeds to S314 and turns on the second heating element 4.

In S313, it may be determined that no snow accumulates in the close-side detection range 15. Then, the CPU 51 proceeds to S315 and turns off the second heating element 4. Then, the CPU 51 returns to S302.

In S316, the CPU 51 determines whether there is a wiper operation request.

In S316, it may be determined that there is no wiper activation request. Then, the CPU 51 proceeds to S317.

In S316, it may be determined that there is a wiper activation request. Then, the CPU 51 returns to S303.

In S317, the CPU 51 determines whether a predetermined time has elapsed.

In S317, it may be determined that the predetermined time has elapsed. Then, the CPU 51 proceeds to S318 and outputs a signal to the wiper control portion 24 so that the wiper blade 21 is retracted to the retracted position 13.

In S317, it may be determined that the predetermined time does not elapse. Then, the CPU 51 returns to S316.

In S319, the CPU 51 determines whether snow accumulates in the close-side detection range 15.

In S319, it may be determined that snow accumulates in the close-side detection range 15. Then, the CPU 51 returns to S316.

In S319, it may be determined that no snow accumulates in the close-side detection range 15. Then, the CPU 51 proceeds to S320 and turns off the second heating element 4. Then, the CPU 51 returns to S302.

1-2-4. Second Snow Chunk Detection Process

By reference to a flowchart illustrated in FIG. 8, the description below explains a second snow chunk detection process performed by the CPU 51 of the body ECU 5 and the CPU 41 of the wiper control portion 24. This process is repeatedly performed while the ignition switch is turned off.

In S401, the CPU 51 determines whether there is a request to stop the wiper motor 22.

In S401, it may be determined that there is a request to stop the wiper motor 22. Then, the CPU 51 proceeds to S402 and turns off the first heating element 3 and the second heating element 4.

In S401, it may be determined that there is no request to stop the wiper motor 22. Then, the CPU 51 returns to S401.

In S403, the CPU 51 notifies the CPU 41 of the request to stop the wiper motor 22.

In S404, the CPU 41 determines whether snow accumulates in the close-side detection range 15.

In S404, it may be determined that snow accumulates in the close-side detection range 15. Then, the CPU 41 proceeds to S405 and controls the wiper motor 22 to immediately stop the wiper blade 21.

In S404, it may be determined that no snow accumulates in the close-side detection range 15. Then, the CPU 41 proceeds to S406 and controls the wiper motor 22 so that the wiper blade 21 moves to the retracted position 13.

1-3. Modification of the First Embodiment

The first embodiment provides the first heating element 3 and the second heating element 4. However, the second heating element 4 may not be provided.

1-3-1. First Snow Chunk Detection Process

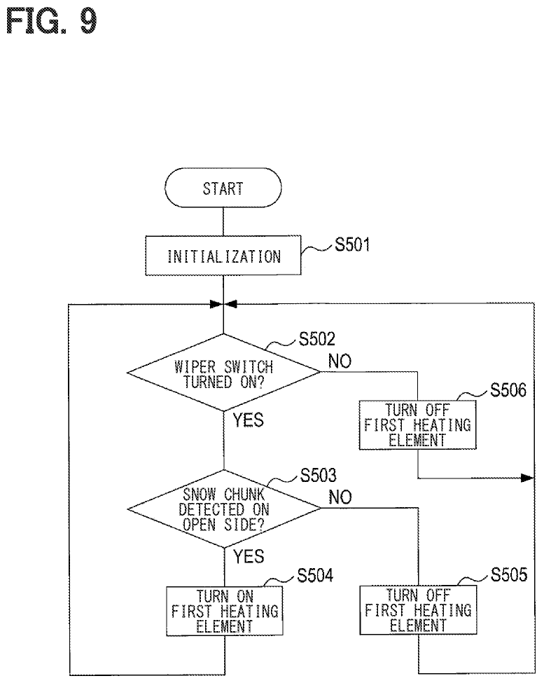

By reference to a flowchart illustrated in FIG. 9, the description below explains the first snow chunk detection process in a configuration where only the first heating element 3 is provided.

In S501, the CPU 51 performs an initialization process. Specifically, the CPU 51 assigns initial values to parameters.

In S502, the CPU 51 determines whether the wiper switch is turned on.

In S502, it may be determined that the wiper switch is turned on. Then, the CPU 51 proceeds to S503.

In S503, the CPU 51 determines whether snow accumulates in the open-side detection range 14. S503 is equal to S303. S503 is comparable to a process as the determination portion.

In S503, it may be determined that snow accumulates in the open-side detection range 14. Then, the CPU 51 proceeds to S504 and turns on the first heating element 3. S504 is comparable to a process as the control portion.

In S503, it may be determined that no snow accumulates in the open-side detection range 14. Then, CPU 51 proceeds to S505 and turns off the first heating element 3.

In S502, it may be determined that the wiper switch is turned off. Then, the CPU 51 proceeds to S506 and turns off the first heating element 3.

1-3-2. Second Snow Chunk Detection Process

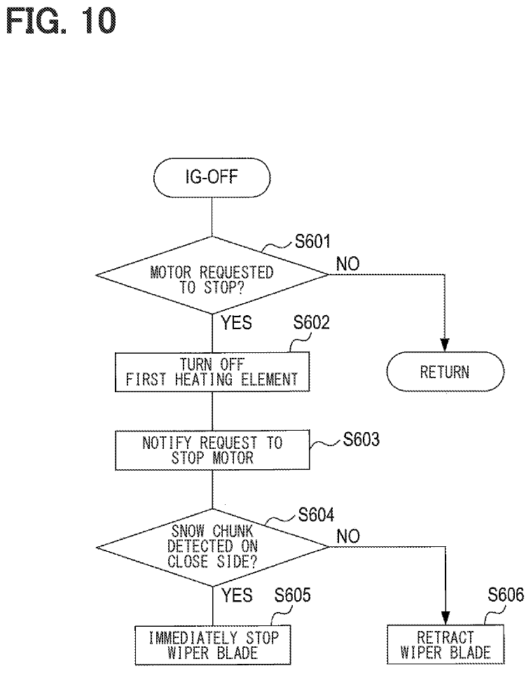

By reference to a flowchart illustrated in FIG. 10, the description below explains the second snow chunk detection process in a configuration where only the first heating element 3 is provided.

In S601, the CPU 51 determines whether there is a request to stop the wiper motor 22.

In S601, it may be determined that there is a request to stop the wiper motor 22. Then, the CPU 51 proceeds to S602 and turns off the first heating element 3.

In S601, it may be determined that there is no request to stop the wiper motor 22. Then, the CPU 51 returns to S601.

In S603, the CPU 51 notifies the CPU 41 of the request to stop the wiper motor 22.

In S604, the CPU 41 determines whether snow accumulates in the close-side detection range 15.

In S604, it may be determined that snow accumulates in the close-side detection range 15. Then, the CPU 41 proceeds to S605 and controls the wiper motor 22 to immediately stop the wiper blade 21.

In S604, it may be determined that no snow accumulates in the close-side detection range 15. Then, the CPU 41 proceeds to S606 and controls the wiper motor 22 so that the wiper blade 21 moves to the retracted position 13.

1-4. Effects

As described in detail above, the first embodiment provides the following effects.

(1a) The CPU 51 turns on the first heating element 3 when it is determined that snow accumulates in the open-side detection range 14. The CPU 51 turns on the second heating element 4 when it is determined that snow accumulates in the close-side detection range 15. This configuration turns on only the heating element closer to a snow chunk. Therefore, this configuration enables to melt snow chunks and to prevent the heating elements from being unnecessarily energized. This configuration enables to efficiently melt the snow accumulated on the windshield 10.

(1b) The first heating element 3 is provided inside the front pillar. This configuration enables to melt the snow accumulated near the released position 12 from the front pillar. The first heating element 3 is hidden from the driver's field of view. Therefore, this configuration enables to prevent the driver's view from being obstructed.

(1c) When the wiper blade 21 is retracted, the CPU 51 turns on the second heating element 4 after determining that snow accumulates in the close-side detection range 15. This configuration enables to melt a snow chunk around the retracted position 13 and then retract the wiper blade 21. This configuration enables to prevent the wiper blade 21 from being damaged by forcibly wiping snow chunks.

1-5. Correspondence Relationship

In terms of the first embodiment, the wiper system 2 corresponds to the wiper system of the snow melting apparatus. The first heating element 3 corresponds to the first heating element of the snow melting apparatus. The second heating element 4 corresponds to the second heating element of the snow melting apparatus. The body ECU 5 corresponds to the determination portion (determiner) and the control portion (controller) of the snow melting apparatus. In terms of the modification of the first embodiment, the wiper system 2 corresponds to the wiper system of the snow melting apparatus. The first heating element 3 corresponds to the first heating element of the snow melting apparatus. The body ECU 5 corresponds to the determination portion (determiner) and the control portion (controller) of the snow melting apparatus.

### 2. Second Embodiment

The basic configuration of the second embodiment is equal to that of the first embodiment. Differences are described below. The same reference numerals as used for the first embodiment depict the same configuration. The preceding explanation is referenced.

The second embodiment differs from the first embodiment in the range to determine whether snow accumulates, corresponding to S303 and S306 in FIG. 7. The second embodiment differs from the first embodiment in the range to determine whether snow accumulates, corresponding to S503 in FIG. 9.

2-1. First Snow Chunk Detection Process

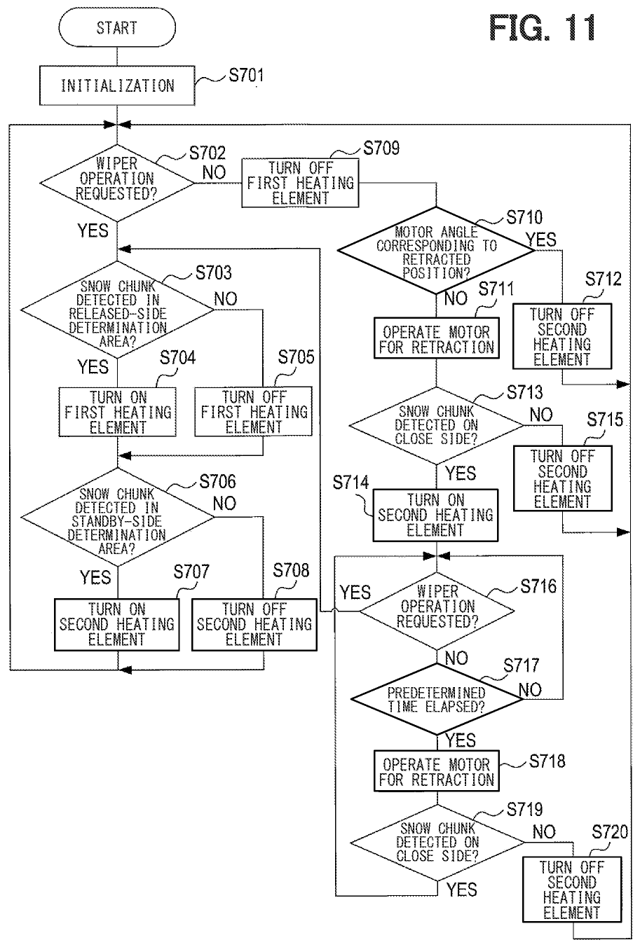

By reference to a flowchart illustrated in FIG. 11, the description below explains the first snow chunk detection process performed by the CPU 51 of the body ECU 5. This process is repeatedly performed while the ignition switch is turned on.

S701 and S702 are equal to S301 and S302.

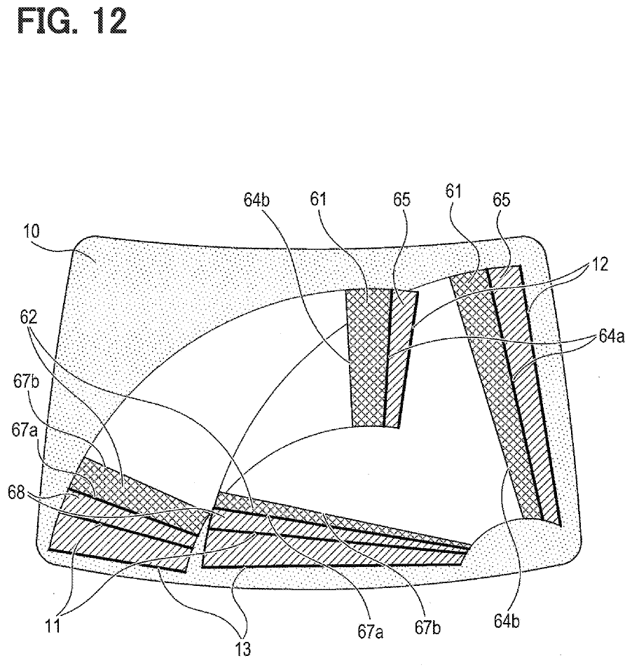

In S703, the CPU 51 determines whether snow accumulates in a released-side determination area 61. As illustrated in FIG. 12, the released-side determination area 61 ranges from a first reference position 64a to a second reference position 64b. The first reference position 64a is distanced from the released position 12 of the wiper blade 21 toward the standby position 11 of the wiper blade 21. The second reference position 64b is distanced from the first reference position 64a toward the standby position 11 of the wiper blade 21. The CPU 51 does not determine whether snow accumulates, in an area 65 from the released position 12 to the first reference position 64a of the wiper blade 21. Specifically, the CPU 41 determines that snow accumulates in the snow chunk detection range when all of the following four conditions are satisfied. The conditions are as follows: the angle sensor 23 indicates an angle corresponding to the released-side determination area 61; the rotation speed of the wiper motor 22 is slower than a predetermined speed threshold; the output current value of the wiper motor 22 is larger than a predetermined current threshold; a predetermined time has elapsed. Under these conditions, it is determined that snow accumulates in the released-side determination area 61. It may be favorable to conclude the detection of a snow chunk at the released position 12 when it is determined that a snow chunk is detected in the released-side determination area 61 in three successive cycles, for example. It may be favorable to provide hysteresis for angles detected by the angle sensor 23. Specifically, suppose it is once determined that snow accumulates in the released-side determination area 61. Then, the first heating element 3 turns on and then off at a reference position that may be shifted toward the released position 12. It is possible to prevent the first heating element 3 from repeatedly turning on and off in a short time. S703 is comparable to a process as the determination portion.

In S703, it may be determined that snow accumulates in the released-side determination area 61. Then, the CPU 51 proceeds to S704 and turns on the first heating element 3. S704 is comparable to a process as the control portion.

In S703, it may be determined that no snow accumulates in the released-side determination area 61. Then, the CPU 51 proceeds to S705 and turns off the first heating element 3.

In S706, the CPU 51 determines whether snow accumulates in a standby-side determination area 62. The standby-side determination area 62 ranges from a first reference position 67a to a second reference position 67b. The first reference position 67a is distanced from the standby position 11 of the wiper blade 21 toward the released position 12 of the wiper blade 21. The second reference position 67b is distanced from the first reference position 67a toward the released position 12 of the wiper blade 21. The CPU 51 does not determine whether snow accumulates, in an area 68 from the retracted position 13 to the first reference position 67a of the wiper blade 21.

In S706, it may be determined that snow accumulates in the standby-side determination area 62. Then, the CPU 51 proceeds to S707 and turns on the second heating element 4.

In S706, it may be determined that no snow accumulates in the standby-side determination area 62. Then, the CPU 51 proceeds to S708 and turns off the second heating element 4.

S709 through S720 are equal to S309 through S320.

2-2. Modification of the Second Embodiment

The second embodiment provides the first heating element 3 and the second heating element 4. However, the second heating element 4 may not be provided.

2-2-1. First Snow Chunk Detection Process

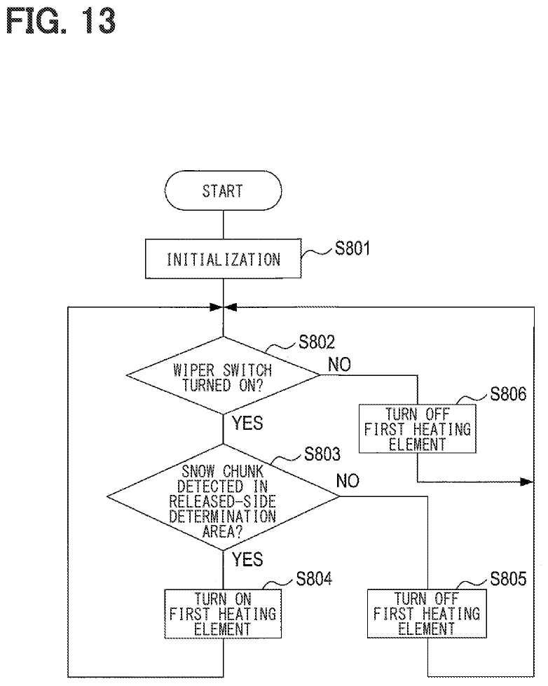

By reference to a flowchart illustrated in FIG. 13, the description below explains the first snow chunk detection process in a configuration where only the first heating element 3 is provided.

S801, S802, and S806 are equal to S501, S502, and S506.

In S803, the CPU 51 determines whether snow accumulates in the released-side determination area 61. S803 is equal to S703. S803 is comparable to a process as the determination portion.

In S803, it may be determined that snow accumulates in the released-side determination area 61. Then, the CPU 51 proceeds to S804 and turns on the first heating element 3. S804 is comparable to a process as the control portion.

In S803, it may be determined that no snow accumulates in the released-side determination area 61. Then, the CPU 51 proceeds to S805 and turns off the first heating element 3.

2-3. Effects

As described in detail above, the second embodiment provides the following effects in addition to the effects of the first embodiment.

(2a) The CPU 51 determines whether snow accumulates in the released-side determination area 61. The released-side determination area 61 ranges from the first reference position 64a to the second reference position 64b. The first reference position 64a is distanced from the released position 12 of the wiper blade 21 toward the standby position 11 of the wiper blade 21. The second reference position 64b is distanced from the first reference position 64a toward the standby position 11 of the wiper blade 21. The CPU 51 does not determine whether snow accumulates, in the area 65 from the released position 12 to the first reference position 64a of the wiper blade 21. This configuration enables to prevent the first heating element 3 from turning on when the snowfall is not enough to turn on the first heating element 3. The first heating element 3 can be used more efficiently.

(2b) The CPU 51 determines whether snow accumulates in the standby-side determination area 62. The standby-side determination area 62 ranges from the first reference position 67a to the second reference position 67b. The first reference position 67a is distanced from the standby position 11 of the wiper blade 21 toward the released position 12 of the wiper blade 21. The second reference position 64b is distanced from the first reference position 67a toward the released position 12 of the wiper blade 21. The CPU 51 does not determine whether snow accumulates, in the area 68 from the retracted position 13 to the first reference position 67a of the wiper blade 21. This configuration enables to prevent the second heating element 4 from turning on when the snowfall is not enough to turn on the second heating element 4. The second heating element 4 can be used more efficiently.

### 3. Other Embodiments

While there have been described the specific preferred embodiments of the present disclosure, it is to be distinctly understood that the disclosure is not limited thereto but may be otherwise variously embodied.

(3a) According to the above-described embodiments, the first heating element 3 is provided inside the front pillar. However, the position to provide the first heating element 3 is not limited thereto. For example, the first heating element 3 may be provided for the windshield 10 near the front pillar as illustrated in FIG. 2D. The first heating element 3 may be provided as a film heater. The first heating element 3 may be attached to the windshield 10 on the side of the vehicle compartment or may be provided between the outer glass and the inner glass constituting the windshield 10.

(3b) According to the above-described embodiments, the body ECU 5 turns on the wiper switch when it is determined that the amount of raindrop detected by the rain sensor 6 exceeds the predetermined raindrop threshold. However, the timing to turn on the wiper switch is not limited thereto. For example, the driver may manually turn on the wiper switch.

(3c) The first embodiment determines whether snow accumulates in the open-side detection range 14 and the close-side detection range 15. The second embodiment determines whether snow accumulates in the released-side determination area 61 and the standby-side determination area 62. However, the ranges to detect the snowfall accumulation are not limited thereto. For example, it may be favorable to detect whether snow accumulates on the whole surface of the windshield 10.

(3d) The above-described embodiments determine the snowfall accumulation in the snow chunk detection range when all of the four conditions are satisfied, namely, the detection range, the rotation speed of the wiper motor 22, the output current value of the wiper motor 22, and the elapsed time. However, other methods may be used to determine the snowfall accumulation in the snow chunk detection range. For example, only part of the four conditions may be used to determine the snowfall accumulation in the snow chunk detection range. A combination with other conditions may be used to determine the snowfall accumulation in the snow chunk detection range. For example, it may be favorable to determine the snowfall accumulation in the snow chunk detection range based on images of a camera installed to capture the surface of the windshield 10. Moreover, the outside temperature may be taken into consideration to determine the snowfall accumulation. Specifically, the above-described determinations may be supplemented with a determination as to whether the value of the outside air temperature sensor is smaller than or equal to a predetermined temperature threshold.

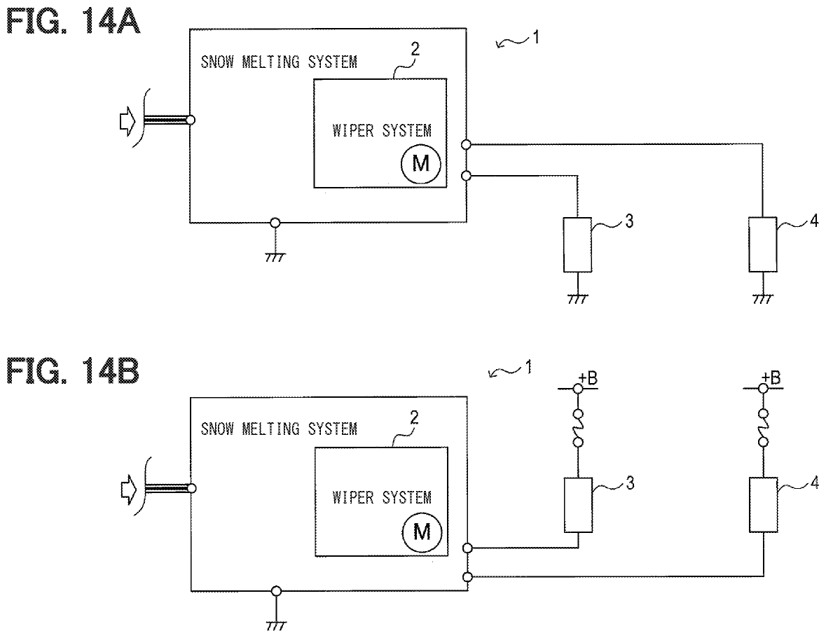

(3e) According to the above-described embodiments, the first heating element 3 and second heating element 4 are powered by the battery, as illustrated in FIGS. 1 and 14B. However, as illustrated in FIG. 14A, the first heating element 3 and the second heating element 4 may be powered by a device included in the snow melting system 1.

(3f) A function of one element in the embodiments may be distributed into several elements. Functions of several elements may be integrated into one element. The configurations of the embodiments may be partially omitted. The configuration of one of the embodiments may be at least partially added to or replace the configurations of the other embodiments.

What is claimed is:

1. A snow melting apparatus comprising:
a wiper system including
a wiper blade to wipe a windshield,
an angle sensor, and
a motor configured to drive the wiper blade to reverse a wipe operation of the wiper blade at a reversal position based on the angle sensor, such that rotation of the motor when the wiper blade moves to a released position is reversed to rotation of the motor when the wiper blade moves to a standby position;
a first heating element installed near a front pillar and configured to generate heat when energized;
a determiner configured to determine whether snow accumulates on a surface of the windshield based on an operation of the wiper system; and
a controller configured to control energization of the first heating element, wherein
the controller is configured to energize the first heating element on determination of the determiner that snow accumulates on the surface of the windshield.

2. The snow melting apparatus according to claim 1, wherein
the first heating element is provided inside the front pillar.

3. The snow melting apparatus according to claim 1, wherein
the first heating element is provided to the windshield near the front pillar.

4. The snow melting apparatus according to claim 1, further comprising:
a second heating element installed near the standby position of the wiper blade and configured to generate heat when energized, wherein
the controller is configured to
control energization of the second heating element and
energize the second heating element on determination of the determiner that snow accumulates on the surface of the windshield.

5. The snow melting apparatus according to claim 4, wherein
the controller is configured to energize the first heating element on determination of the determiner that snow accumulates in a first region around the released position of the wiper blade, and
the controller is configured to energize the second heating element on determination of the determiner that snow accumulates in a second region around the standby position of the wiper blade.

6. The snow melting apparatus according to claim 1, wherein
the determiner is configured to determine whether snow accumulates on the surface of the windshield based on a region that ranges from a first reference position to a second reference position,
the first reference position is distanced from the released position of the wiper blade toward the standby position of the wiper blade, and
the second reference position is distanced from the first reference position toward the standby position of the wiper blade.

7. The snow melting apparatus according to claim 6, wherein
the determiner is configured not to determine whether snow accumulates on the surface of the windshield in a non-determination region between the released position and the first reference position.

8. A snow melting apparatus comprising:
at least one processor configured to
cause a wiper blade to wipe a windshield of a vehicle between a released position and a standby position by controlling an output current of a motor to reverse between rotation of the motor when the wiper blade moves to the released position and rotation of the motor when the wiper blade moves to the standby position based on a signal from an angle sensor that is configured to detect a rotational position of the motor;
determine whether snow accumulates on a surface of the windshield based on an operation of at least one of the signal from the angle sensor and the output current of the motor; and
energize a first heating element installed near a front pillar of the vehicle to generate heat on determination that snow accumulates on the surface of the windshield.
